(19) United States
(12) Patent Application Publication
(10) Pub. No.: US 2008/0270719 A1
(43) Pub. Date: Oct. 30, 2008

(54) Method and system for efficient snapshot operations in mass-storage arrays

(76) Inventors: Robert A. Cochran, Sacramento, CA (US); Ayman Abouelwafa, Folsom, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/799,267

(22) Filed: Apr. 30, 2007

(51) Int. Cl. G06F 12/00

(52) U.S. Cl. 711/162

(57) ABSTRACT

Embodiments of the present invention are directed to efficient snapshot operations that produce multiple, useable snapshot logical units when successively directed to a logical unit, and to mass-storage arrays that support such efficient snapshot operations. In one embodiment of the present invention, allocate-on-write techniques are employed for handling WRITE access operations directed to storage-allocation units not yet overwritten following a snapshot operation. The allocate-on-WRITE technique is enhanced by a background process that continuously defragments the logical-storage-allocation-unit address space referenced by the original logical unit.

### TECHNICAL FIELD

The present invention is related to disk arrays, other mass-storage-device arrays, and mass-storage systems in general, and is related, in particular, to an efficient snapshot operation for producing a virtual copy of a logical unit, volume, or other data-storage unit within a mass-storage system.

### BACKGROUND OF THE INVENTION

The data capacities and data-access speeds of mass-storage devices have increased phenomenally during the past 50 years, at rates even greater than the often-discussed rate of increase in processor speeds and functionalities. Large, rigid, removable disk platters used in many computers during the 1970's stored less than a megabyte of data, while relatively low-cost personal computers can now be purchased with small, terabyte drives. In early computer systems, mass-storage devices were generally directly interconnected with the computer processor, electronic memory, and other computer-system components. More recently, large, highly-available and fault-tolerant mass-storage arrays and other mass-storage systems have been developed both as peripheral mass-storage devices directly linked to individual computer systems as well as for use as more autonomous, remote mass-storage systems accessible to many different computer systems through communications networks.

In general, mass-storage arrays provide a logical-unit-based interface to host computers. The data-storage space provided by the mass-storage-devices within a mass-storage array is partitioned into multiple logical units by the mass-storage array controller. Logical units provide a useful level of indirection between host-computer-specified logical data addresses and the data addresses by which mass-storage array controllers access the mass-storage devices under their control. The snapshot operation is one example of the operations provided to host computers by mass-storage arrays. Although snapshots may be undertaken on various different data granularities, snapshot operations are discussed with reference to logical units in this and following sections. A snapshot operation allows a host computer to direct an array controller to make a nearly instantaneous copy of a particular logical unit. Following the snapshot operation, the original logical unit and the snapshot-logical-unit copy can be independently accessed. Although snapshot operations have proved to be quite useful to mass-storage array vendors, users, and administrators, and are currently provided by most mass-storage arrays, snapshot operations are currently inefficient, and only a single snapshot logical unit of multiple snapshot logical units produced by successive snapshot operations directed to an original logical unit may be useable, as discussed below. For these reasons, designers, manufacturers, vendors, and users of mass-storage arrays, and other mass-storage devices, have recognized the need for an efficient snapshot operation that provides for effective, successive snapshots of a logical unit or other data-storage unit.

### SUMMARY OF THE INVENTION

Embodiments of the present invention are directed to efficient snapshot operations that produce multiple, useable snapshot logical units when successively directed to a logical unit, and to mass-storage arrays that support such efficient snapshot operations. In one embodiment of the present invention, allocate-on-write techniques are employed for handling WRITE access operations directed to storage-allocation units not yet overwritten following a snapshot operation. The allocate-on-WRITE technique is enhanced by a background process that continuously defragments the logical-storage-allocation-unit address space referenced by the original logical unit.

### BRIEF DESCRIPTION OF THE DRAWINGS

FIG. 1 shows, at a very high level of abstraction, a traditional disk array.

FIG. 2 illustrates the logical-storage-allocation-unit map for a mass-storage device.

FIG. 3 illustrates redundant storage of data in an array and a logical device in an array.

FIG. 4 illustrates conventions used in the following discussion.

FIG. 5 illustrates an internal logical-unit map maintained by an array controller.

FIG. 6 illustrates a snapshot operation.

FIG. 7 illustrates a WRITE operation directed to a preferred storage-allocation unit of an original logical unit.

FIG. 8 illustrates divergence of a snapshot logical unit from an original logical unit.

FIG. 9 illustrates use of a snapshot to restore the original logical unit.

FIG. 10 shows successive snapshot operations.

FIG. 11 illustrates the example of FIG. 10 following restoration of an original logical unit from a snapshot logical unit.

FIG. 12 illustrates an alternative method for handling WRITE operations directed to a storage-allocation unit not yet overwritten following a snapshot operation according to one embodiment of the present invention.

FIG. 13 illustrates an original-logical-unit map and snapshot-logical-unit map following divergence as a result of WRITE operations directed to either or both of the original logical unit or snapshot logical unit following a snapshot operation according to one embodiment of the present invention.

FIG. 14 illustrates defragmentation of logical storage-allocation-unit address space according to one embodiment of the present invention.

FIG. 15 illustrates a second, successive snapshot operation according to one embodiment of the present invention.

FIG. 16 shows a restore operation directed to a first snapshot logical unit according to one embodiment of the present invention.

FIG. 17 is a control-flow diagram for writing to a storage-allocation unit not yet overwritten following a snapshot operation according to one embodiment of the present invention.

FIG. 18 is a control-flow diagram for a restore operation according to the present invention.

### DETAILED DESCRIPTION OF THE INVENTION

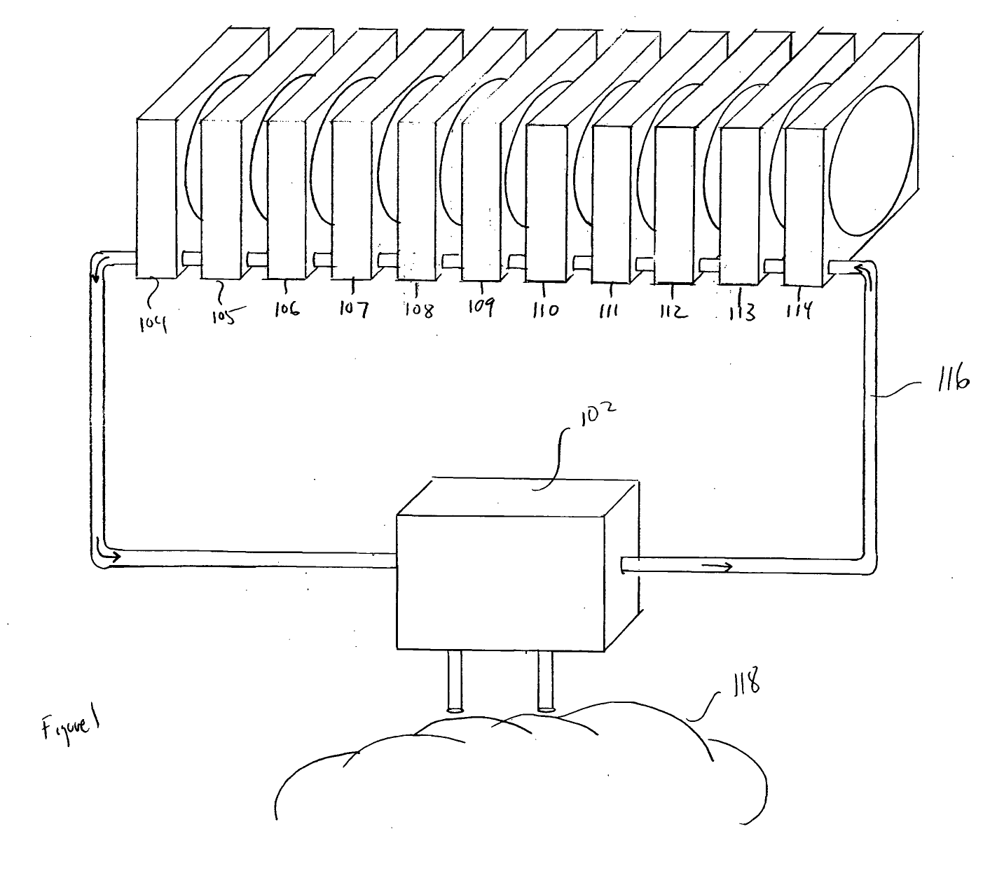

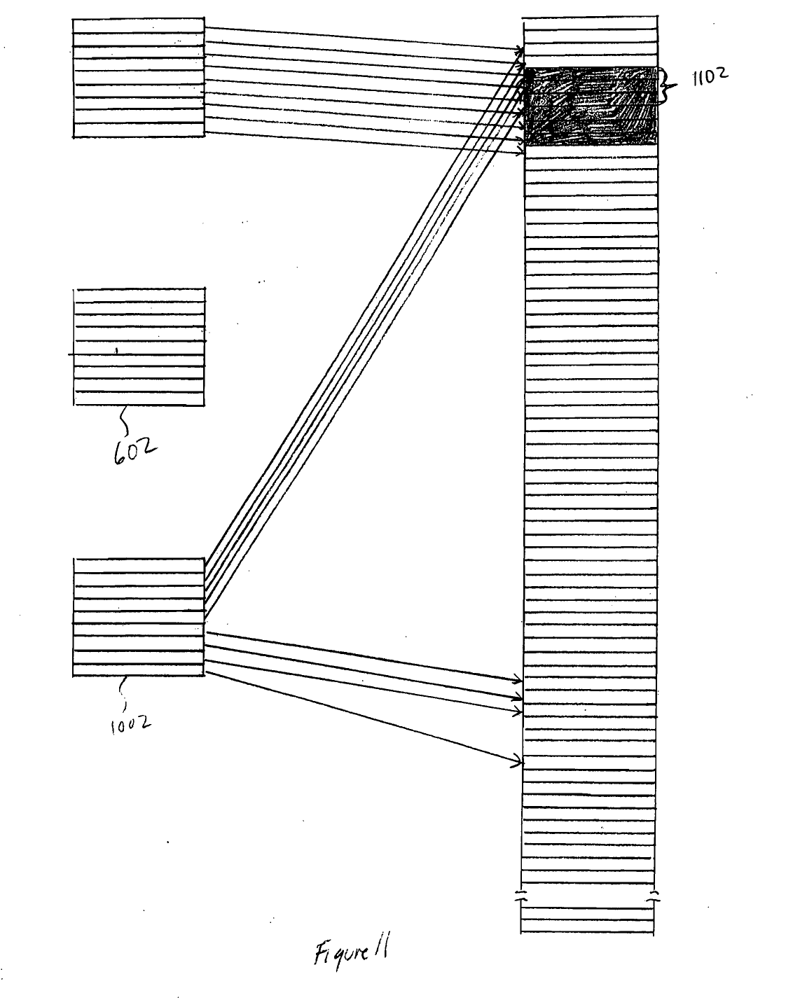

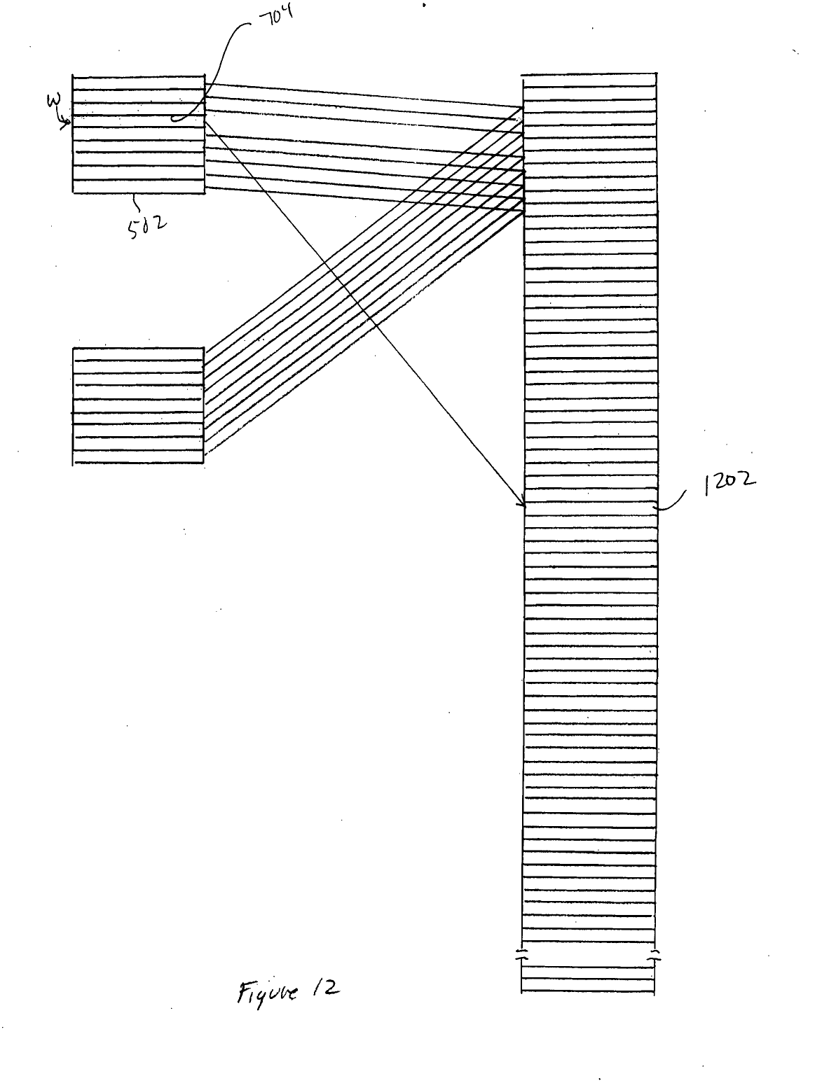

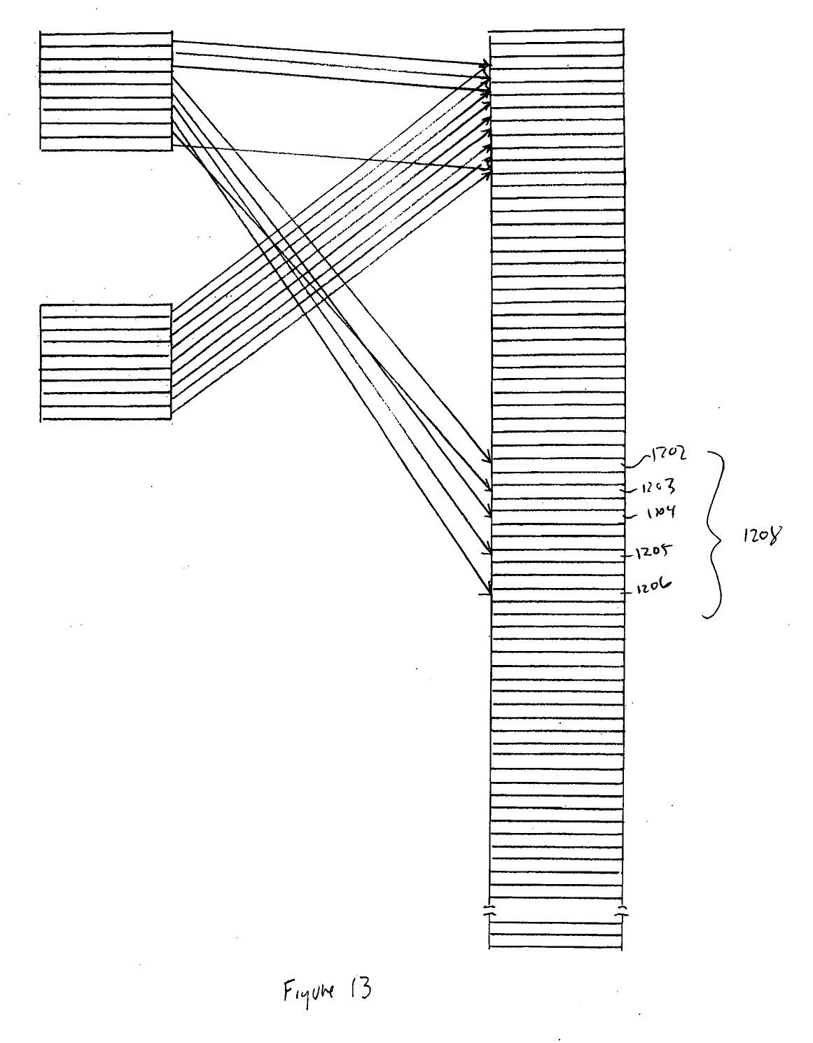

Method and system embodiments of the present invention are directed to efficient snapshot operations that produce useable, multiple snapshot logical units when successively applied to a logical unit. These efficient snapshot operations involve allocate-on-write techniques, background defragmentation of storage-allocation-unit address space, and a particular method for carrying out successive snapshot operations. First, an overview of mass-storage arrays and storage-allocation units is provided with reference to FIGS. 1-4. Next, traditional snapshot operations, and problems associated with traditional snapshot operations, are discussed with reference to FIGS. 11-12. Then, method embodiments of the present invention are discussed with reference to FIGS. 13-16. Finally, control-flow diagrams are provided for aspects of snapshot operations that represent embodiments of the present invention.

FIG. 1 shows, at a very high level of abstraction, a traditional disk array. The disk array includes a disk-array controller 102 and multiple mass-storage devices, commonly multi-platter disk drives 104-114, generally linked together by one or more high-bandwidth communications media 116 internal to the disk array. The data stored within the disk array is accessed, by host computers, through an external communications medium 118. FIG. 1 is not intended to illustrate the actual appearance of a disk array, or describe the many additional components within a disk array, including redundant power supplies, various peripheral devices, consoles, and other such components. Instead, for the purposes of describing the present invention, it is sufficient to understand that the basic disk-array architecture comprises a disk-array controller interconnected with multiple mass-storage devices.

In general, the disk-array controller includes one or more processors and controller firmware and software that together implement a logical-unit-based interface through which remote host computers access data stored on the mass-storage devices. The disk-array controller 102 translates logical unit numbers (“LUNs”) and data addresses associated with LUNs to logical addresses directed to individual mass-storage devices. In addition, the disk-array controller includes sophisticated logic for automatic, redundant storage of data, for remapping stored data in the event of hardware problems or faults, and for many other functionalities directed to providing highly-available, fault-tolerant, and flexible data storage on behalf of remote host computers.

In the following discussion, mass-storage arrays are alternatively referred to as “arrays,” and mass-storage-array controllers are referred to as “array controllers.” While disk arrays commonly include many high-capacity and high-speed disk devices, arrays may employ additional types of mass-storage devices and/or combinations of different types of mass-storage devices. The present invention is not concerned with details of data storage at the mass-storage-device level, and is applicable to arrays employing any number of different types of mass-storage devices.

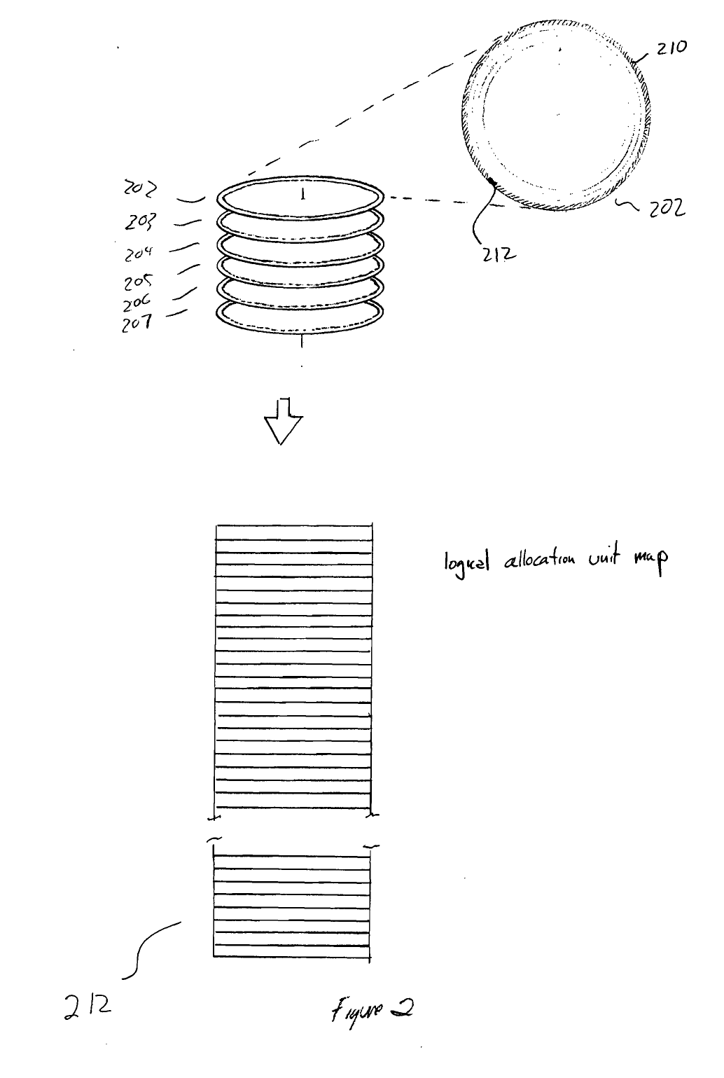

FIG. 2 illustrates the logical-storage-allocation-unit map for a mass-storage device. As shown in FIG. 2, a modern disk storage device comprises multiple platters 202-207. The platters are coated with a magnetically bistable substance that allows them to be written and read by application of magnetic fields applied to tiny portions of the platters as they rotate beneath magnetic READ/WRITE heads. Each platter, such as platter 202, comprises multiple circular tracks such as the first track 210 of platter 202, and each track is divided into multiple sectors, such as the sector 212 shown in FIG. 2 with dark shading. In general, mass-storage arrays support a preferred storage-allocation unit for READ and WRITE accesses. The preferred storage-allocation unit may be selected to be a sector, track, or cylinder comprising each of a particular track on both sides of all of the platters. Additional preferred storage-allocation units comprising multiples of sectors, tracks, or cylinders, are also possible. In many cases, the preferred storage-allocation unit is selectable, and negotiated by the array controller and host computers. An array controller contains an internal, memory map 212 for each mass-storage device in the array that represents a logical, continuous preferred-storage-allocation-unit address space. The map essentially represents a logical address space for all of the preferred storage-allocation units within the mass-storage device.

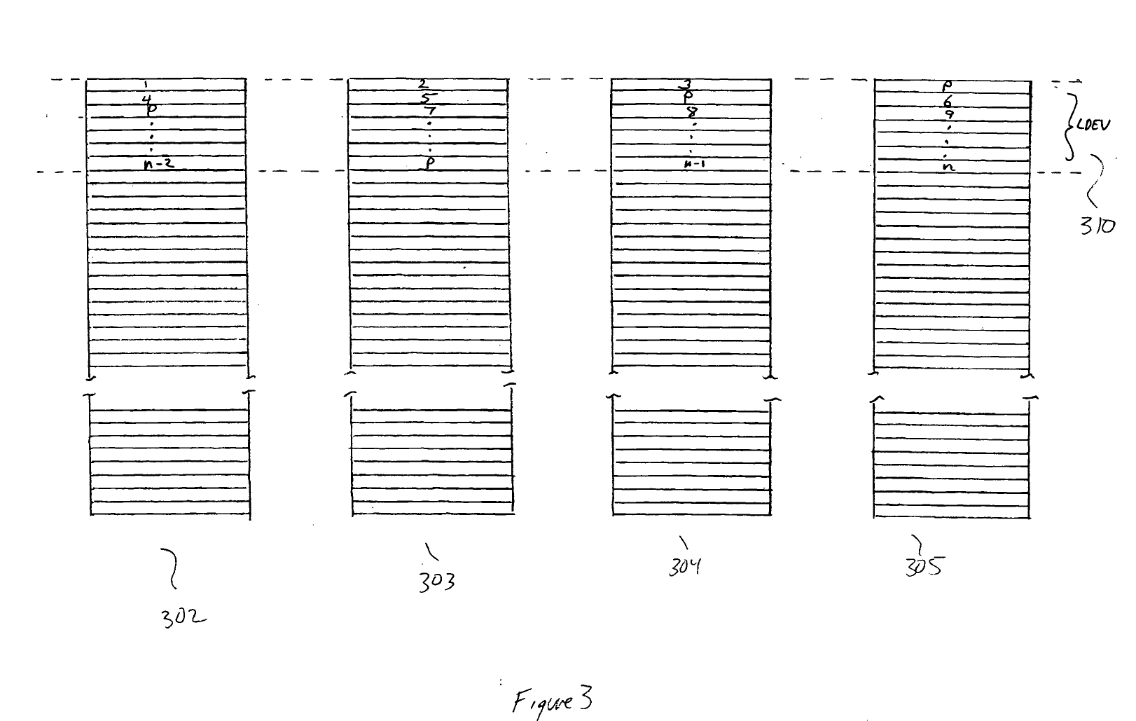

FIG. 3 illustrates redundant storage of data in an array and a logical device in an array. In FIG. 3, the logical address spaces for four mass-storage devices 302-305 are shown. In general, storage space is allocated in units of logical devices, each logical device comprising a set of identical tracks from each of two or more mass-storage devices. In FIG. 3, a logical device 310 is shown mapped to the first seven preferred storage-allocation-unit addresses of each of the four mass-storage devices 302-305. Thus, the logical comprises, in FIG. 3, seven 3tripes of each of the four mass-storage devices, where a stripe is a set of identical preferred storage-allocation-unit addresses on each of the mass-storage devices. A stripe includes a number of storage-allocation units that contain data, and a smaller number of storage-allocation units containing parity bytes computed from the storage-allocation-units of the stripe containing data. This technique is referred to as “erasure coding” redundancy, and is used to provide for recovery of information stored in a logical device in the event of failures of one or more of the mass-storage devices on which the logical device is implemented. The number of mass-storage-device failures, within a group of mass-storage devices that together implement a logical device, that can be tolerated without data loss depends on the number of parity-containing storage-allocation units within each stripe.

In addition to the data redundancy discussed with reference to FIG. 3, mass-storage arrays, and other mass-storage devices, generally contain large amounts of cache memory for storing frequently accessed storage-allocation units, so that, rather than accessing mass-storage devices, the array controller can immediately write to, or read from, cached copies of the storage-allocation units. Array controllers generally manage storage of data within mass-storage arrays through complex mappings and distribution of data across mass-storage devices and between mass-storage devices in memory. In the interest of brevity and clarity, much of this detail is avoided, in the following discussion. Rather than discuss, for the described snapshot operations, all of the detailed mappings and distributions, it is assumed that the array controller carries out these distributions and mappings in traditional fashion.

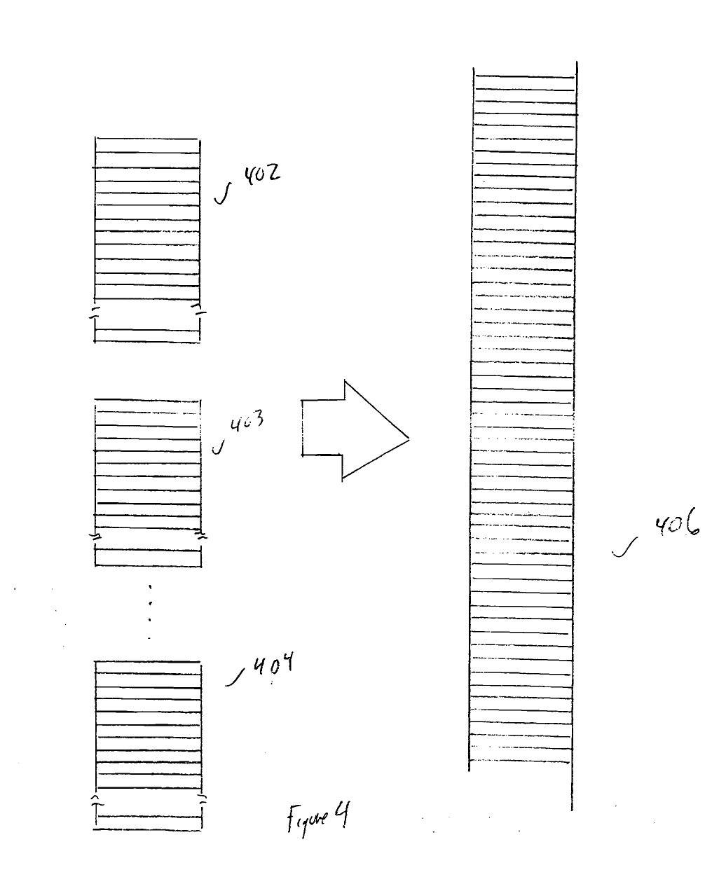

FIG. 4 illustrates conventions used in the following discussion. As shown in FIG. 4, all of the logical storage-allocation-unit address spaces for all of the mass-storage devices in an array 402-404 are logically combined together to produce a single, continuous, logical storage-allocation-unit address space 406. Again, a single, continuous, logical storage-allocation-unit address space represents a complex mapped and distributed data-storage system maintained by the array controller.

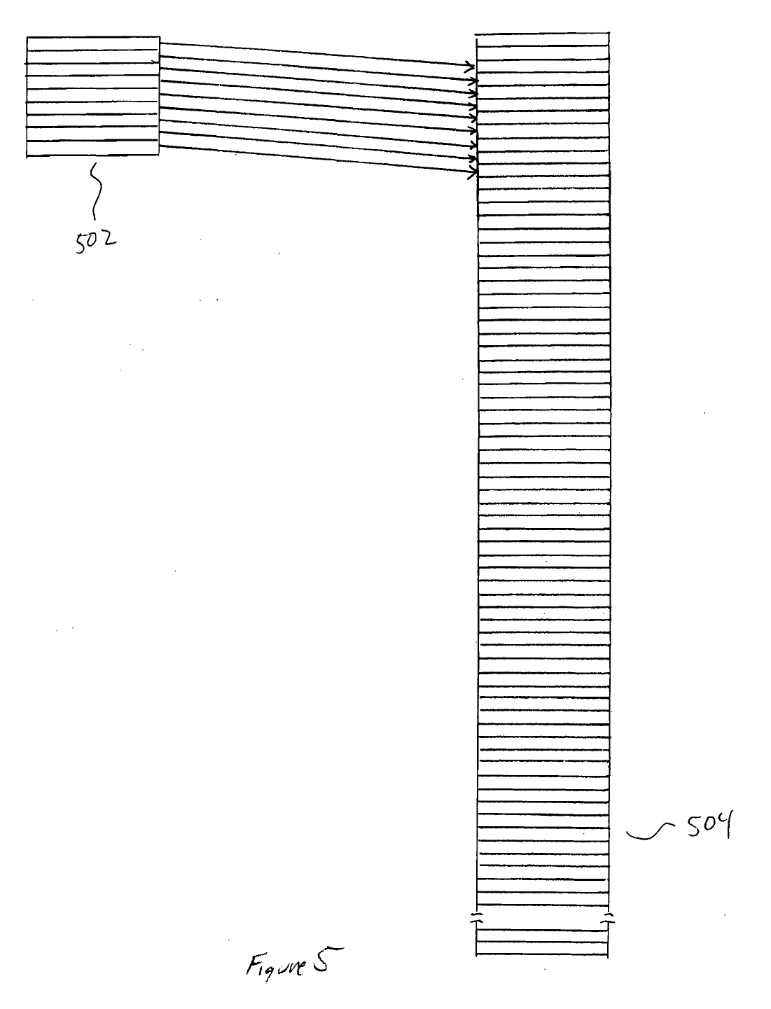

FIG. 5 illustrates an internal logical-unit map maintained by an array controller. As shown in FIG. 5, an array controller maintains an internal, memory map 502 for each logical unit, logical volume, or other data-storage unit provided by the array controller to remote host computers. In the following discussion, snapshot operations are discussed with reference to logical units, but the same principals may apply for snapshot operations directed to logical volumes, and other data-storage units provided by an array controller to remote, host computers. The internal logical unit map 502 in FIG. 5 contains references, for each preferred storage-allocation unit in the logical unit, to the single, continuous, logical storage-allocation-unit address space 504 maintained by the array controller, and discussed above with reference to FIGS. 3 and 4. Thus, the internal logical-unit map 502 maps a logical unit to mass-storage devices and cache memory.

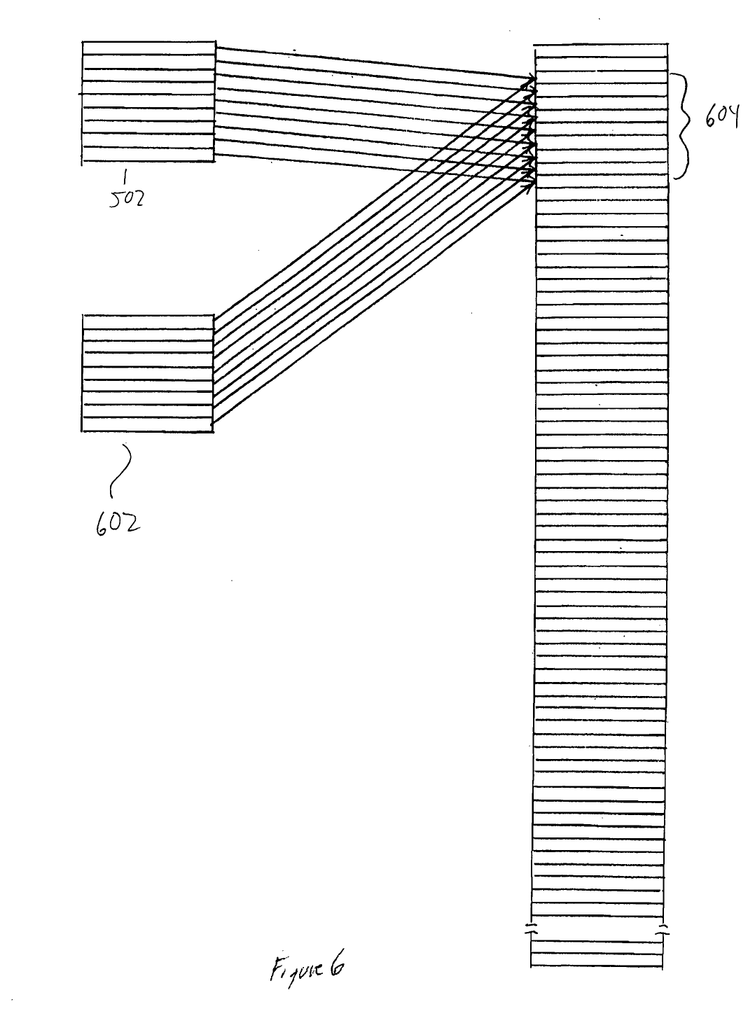

FIG. 6 illustrates a snapshot operation. In a snapshot operation, an array-controller is directed, by a host computer, to create a virtual copy of a logical unit. The virtual copy is created nearly instantaneously, in memory operations, as shown in FIG. 6. In FIG. 6, a snapshot logical unit map 602 has been created by the array controller, with references to the same set of preferred storage-allocation units 604 referenced by the original logical unit 502. Thus, a relatively simple, memory operation comprising copying an internal, original logical-unit map to create a snapshot logical-unit map results in a nearly instantaneous virtual copy of the original logical unit which is intended to represent the data in 502 at a specific point in time.

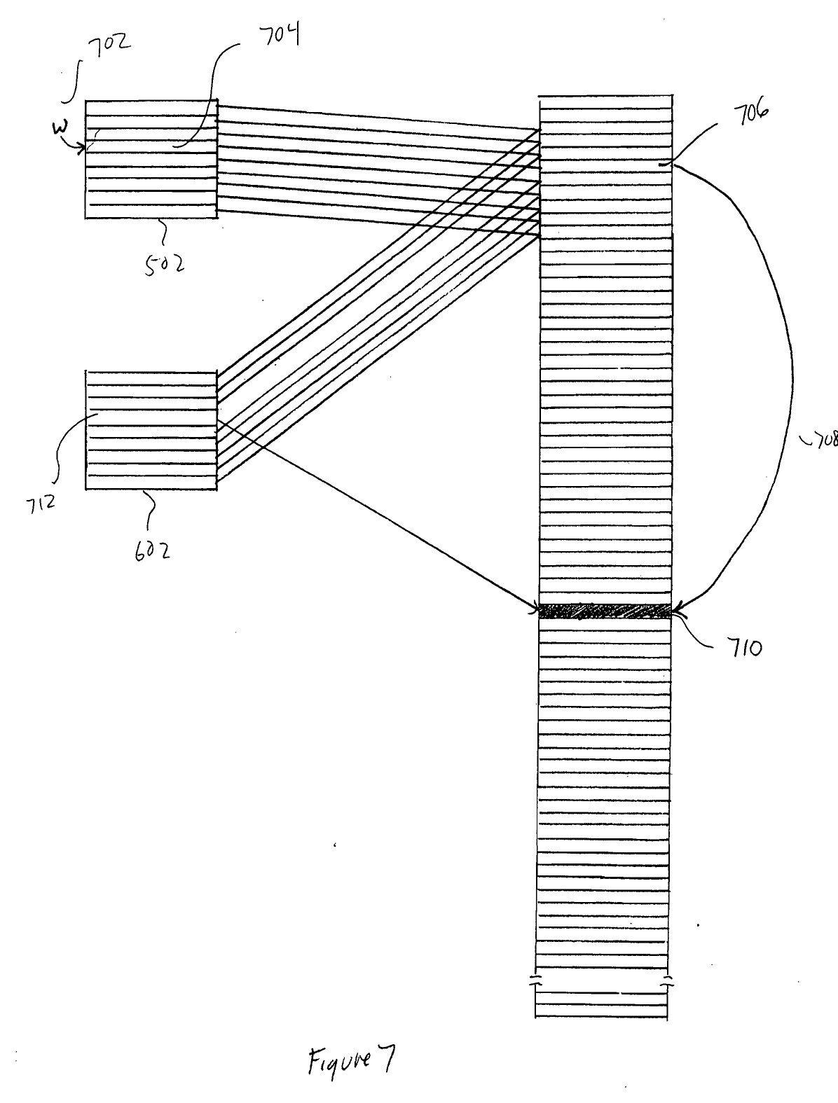

FIG. 7 illustrates a WRITE operation directed to a preferred storage-allocation unit of an original logical unit not yet overwritten following a snapshot operation. As shown in FIG. 7, when a WRITE operation 702 is directed to a preferred storage-allocation unit 704 of the original logic unit 502, the data stored in the preferred storage-allocation unit 706, referenced by the entry 704 of the internal map 502 for the storage-allocation unit to be written, is copied 708 to a newly allocated storage-allocation unit 710, and the entry 712 of the snapshot logical-unit map 602 is updated to reference the newly allocated storage-allocation unit 710. Thus, the logical content of the snapshot logical-unit map 602 still represents the data contained within the original-logical-unit map 502 as of the moment of the snapshot creation. Finally, the WRITE operation is carried out to the storage-allocation unit 706 referenced by the entry 704 of the original-logical-unit map 502 to which the WRITE is directed. Note that, in the traditional snapshot operation, executing a WRITE operation to a storage-allocation unit that is referenced by both the original-logical-unit map 502 and the snapshot-logical-unit map 602 involves accessing the storage-allocation unit to read the contents of the storage-allocation unit, copying the contents of the storage-allocation unit to a newly allocated storage-allocation unit, and then a WRITE access to the original storage-allocation unit to execute the WRITE-access operation. After a storage-allocation unit of either the original logical unit or the snapshot logical unit has been overwritten, following a snapshot operation, subsequent WRITE operations directed to the storage-allocation unit can be carried out directly, with reference to either the original-logical-unit map 502 or the snapshot-logical-unit map, respectively. In other words, the performance intensive one-READ-and-two-WRITE operation illustrated in FIG. 7 needs to be carried out only for storage-allocation units not yet overwritten following a snapshot operation.

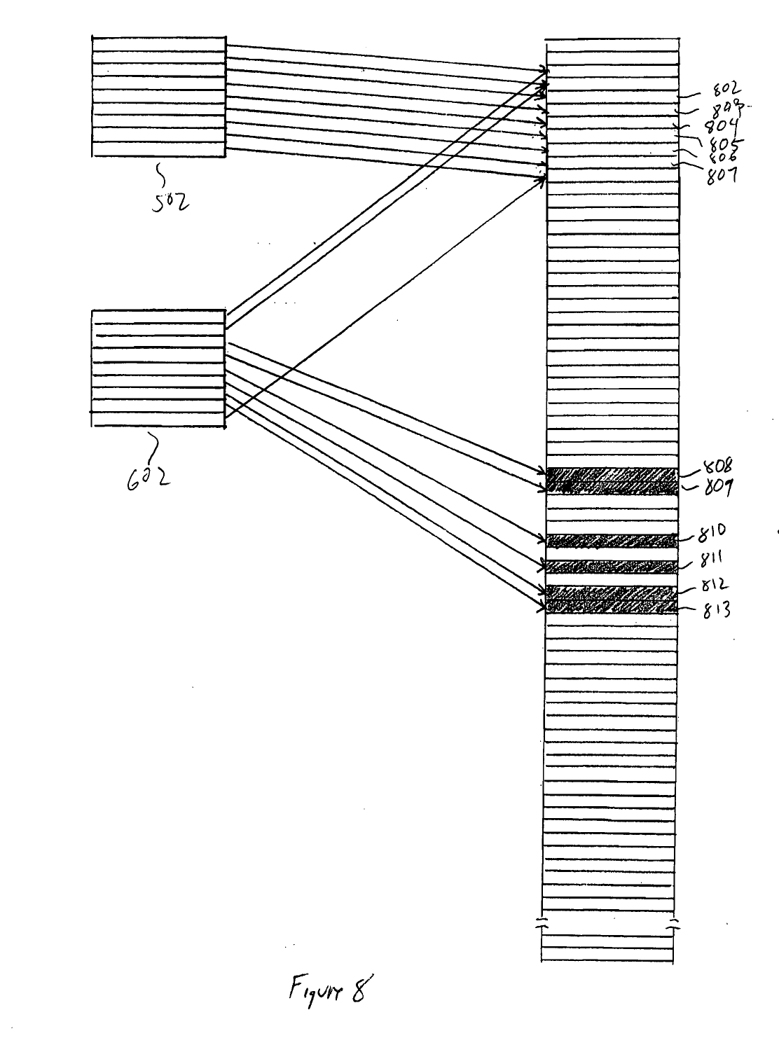

FIG. 8 illustrates divergence of a snapshot logical unit from an original logical unit. As shown in FIG. 8, after some time following the snapshot operation, the original-logical-unit map 502 and the snapshot-logical-unit map 602 may significantly diverge as a result of the copy-on-write operations discussed with reference to FIG. 7. Thus, in FIG. 8, the third through eighth storage-allocation units 802-807 of the original logical unit have been overwritten, following the snapshot operation. For these storage-allocation units, new storage-allocation units 808-813 have been allocated, and are now referenced by the snapshot-logical-unit map 602.

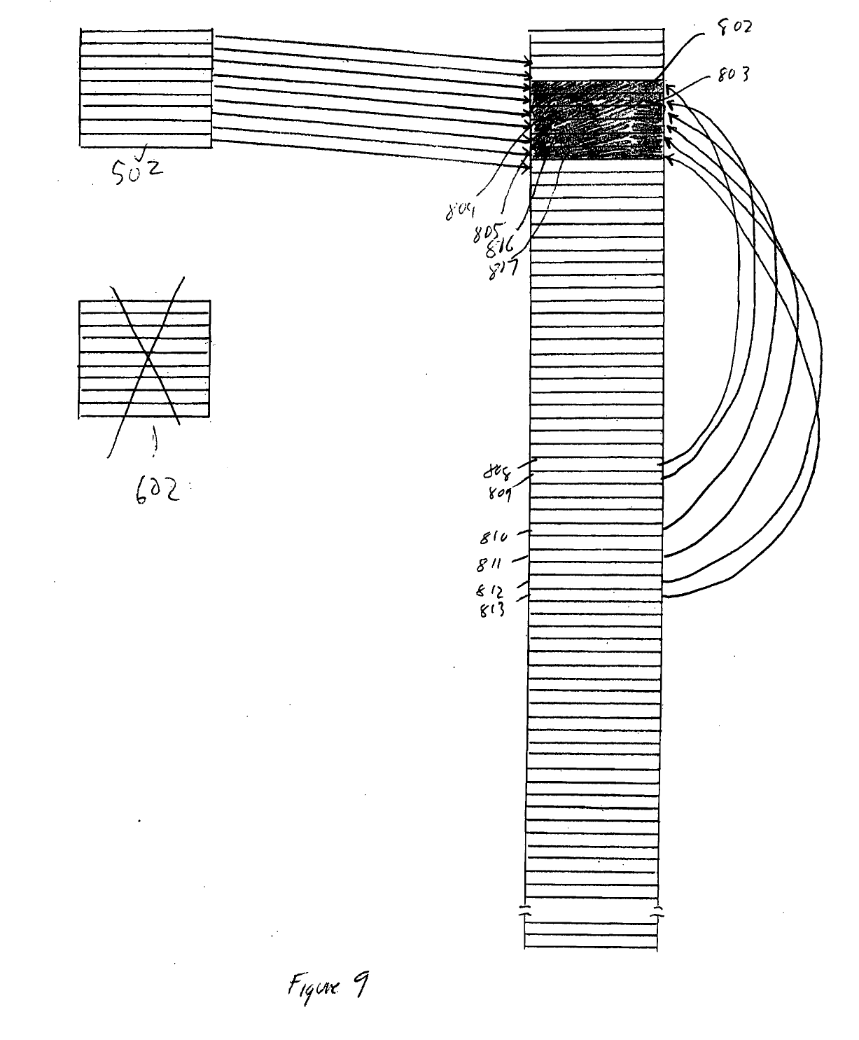

FIG. 9 illustrates use of a snapshot to restore an original logical unit. As shown in FIG. 9, an original-logical unit can be returned to the state that it had at a time just prior to the snapshot operation by copying all of the original storage-allocation units referenced by the snapshot-logical-unit map 808-813 back to the corresponding, original storage-allocation units 802-807, deallocating those storage-allocation units, and deallocating the snapshot-logical-unit map 602. At this point, the original-logical-unit map 502 references the data that the original-logical-unit map referenced just prior to the snapshot operation.

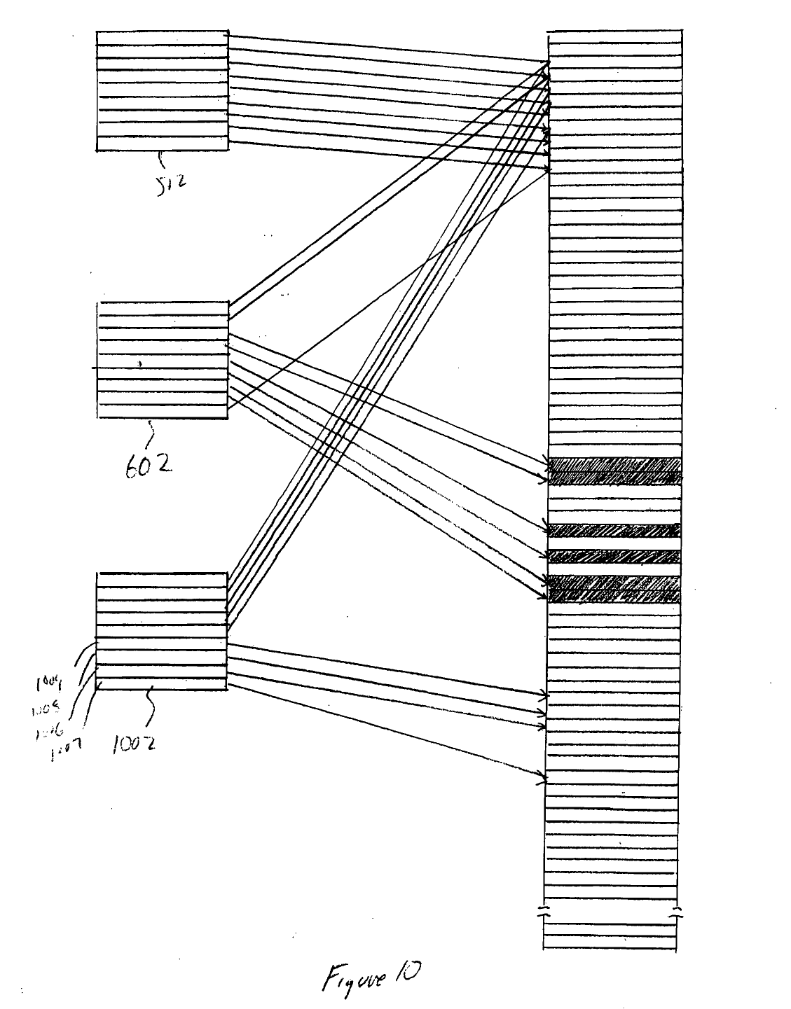

FIG. 10 shows successive snapshot operations. In FIG. 10, a second snapshot logical unit 1002 has been created by a second snapshot operation, following the first snapshot operation that produced the first snapshot logical unit 602. Following this second snapshot operation, the final four storage-allocation units 1004-1007 of the second snapshot have been overwritten, causing divergence of the second snapshot from the original logical unit 502. Thus, the second snapshot logical unit 1002 represents the data state of the original logical unit 502 at a second point in time. Successive snapshot operations may be directed to an original logical unit by a host computer in order to preserve a sequence of data states at particular time points. This may allow the host computer to fall back to a selected, intermediate data state as a result of detected errors or as part of rollback operations.

FIG. 11 illustrates the example of FIG. 10 following restoration of an original logical unit from a snapshot logical unit. As shown in FIG. 11, a restore operation has been directed to the first snapshot logical unit 602, resulting in copying of original storage-allocation units referenced uniquely by the first snapshot logical unit (808-813 in FIG. 8) back to the original storage-allocation units (802-807 in FIG. 8) from which they were copied by copy-on-write operations, discussed above. However, consider the effect on the second snapshot logical unit 1002. The second snapshot logical unit is supposed to represent the data state of the original logical unit at a second point in time, following the first snapshot operation. However, due to the restoration operation employing the first snapshot logical unit 602, original data has been copied over three storage-allocation units 1102 that are referenced by the second snapshot logical unit. These three storage-allocation units may have been subsequently altered by WRITE operations directed to the original logical unit. These three storage-allocation units are supposed to contain the data states of the storage-allocation units following the first snapshot operation. Thus, restoring the original logical unit from the first snapshot logical unit 602 has essentially corrupted the second snapshot logical unit 1002.

Thus, traditional snapshot operations have two significant problems. First, as discussed above, the copy-on-write operations needed to carry out WRITE operations directed to storage-allocation units that have not been overwritten following a snapshot operation are performance inefficient, requiring a READ and two WRITE operations directed to mass-storage devices. Furthermore, when successive snapshot operations are carried out against a logical unit, restoring the original logical unit from any one of the successive snapshot operations may compromise or destroy the remaining snapshot logical units of the set of successive snapshot logical units. A host computer might need to try to restore several of the data states represented by successively generated snapshot logical units, and thus may expect to rely on more than a single snapshot logical unit. However, because of the nature of the traditional snapshot operations, a host computer can depend on only employing one of a series of snapshot logical units obtained by successive snapshot operations directed to an original logical unit.

FIG. 12 illustrates an alternative method for handling WRITE operations directed to a storage-allocation unit not yet overwritten following a snapshot operation according to one embodiment of the present invention. FIG. 12 illustrates a first WRITE operation directed to the fourth storage-allocation unit 704 in the original logical unit 502. As shown in FIG. 12, rather than employing the copy-on-write technique, discussed with reference to FIG. 7, above, the array controller instead allocates a new storage-allocation unit 1202, executes the WRITE operation to the newly allocated storage-allocation unit 1202, and then updates the original-logical-unit map 502 to reference the newly allocated storage-allocation unit 1202. Should the WRITE operation have a granularity less than the preferred storage-allocation unit, or, in other words, write only a portion of the containing preferred storage-allocation unit, then the data currently stored in the preferred storage-allocation unit needs to be read into memory, and the WRITE operation directed to the in-memory copy of the preferred storage-allocation unit, prior to writing the in-memory copy to the newly allocated storage-allocation unit.

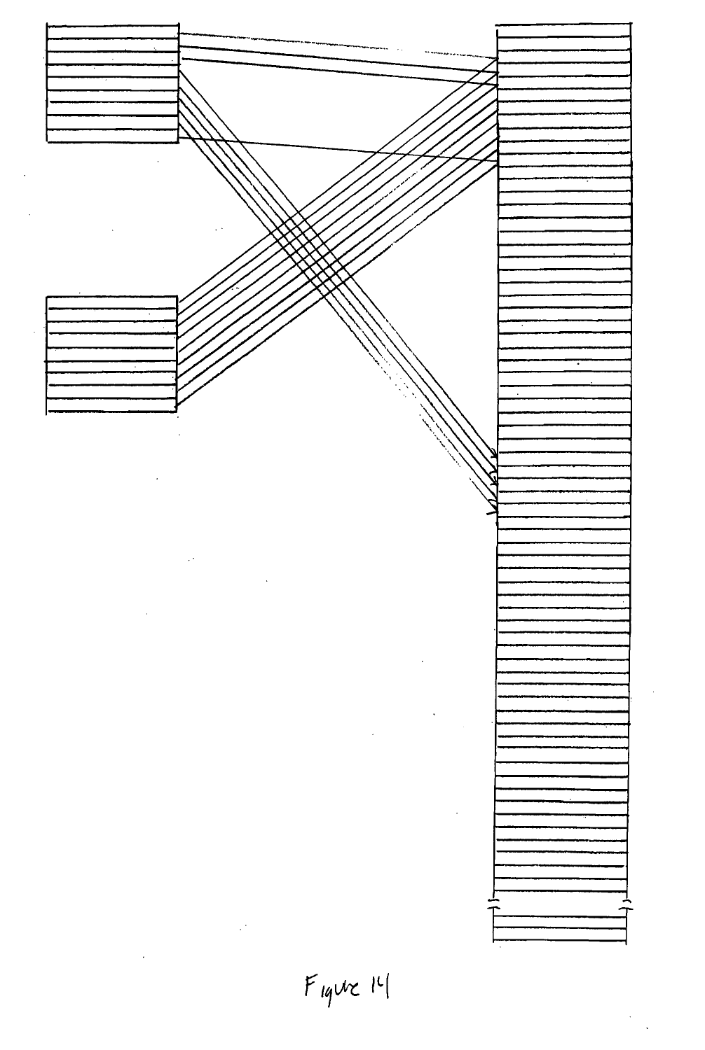

FIG. 13 illustrates an original-logical-unit map and snapshot-logical-unit map following divergence as a result of WRITE operations directed to either or both of the original logical unit or snapshot logical unit following a snapshot operation according to one embodiment of the present invention. FIG. 13 illustrates the example shown in FIG. 8, but with divergence resulting from allocate-on-write operations rather than copy-on-write operations. Note that, in FIG. 13, the newly allocated storage-allocation units 1202-1206 are not necessarily located at consecutive logical storage-allocation-unit addresses, but are distributed over a region of logical-storage-allocation-unit address space 1208. For many reasons, it is desirable for successive original-logical-unit storage-allocation units to be consecutively ordered with respect to logical storage-allocation-unit address space. FIG. 14 illustrates defragmentation of logical storage-allocation-unit address space according to one embodiment of the present invention. In order to enhance the efficient snapshot operation of the present invention, a background process runs on the array controller to periodically defragment the region of logical-storage-allocation-unit address space containing storage-allocation units allocated on behalf of the original logical unit following a snapshot.

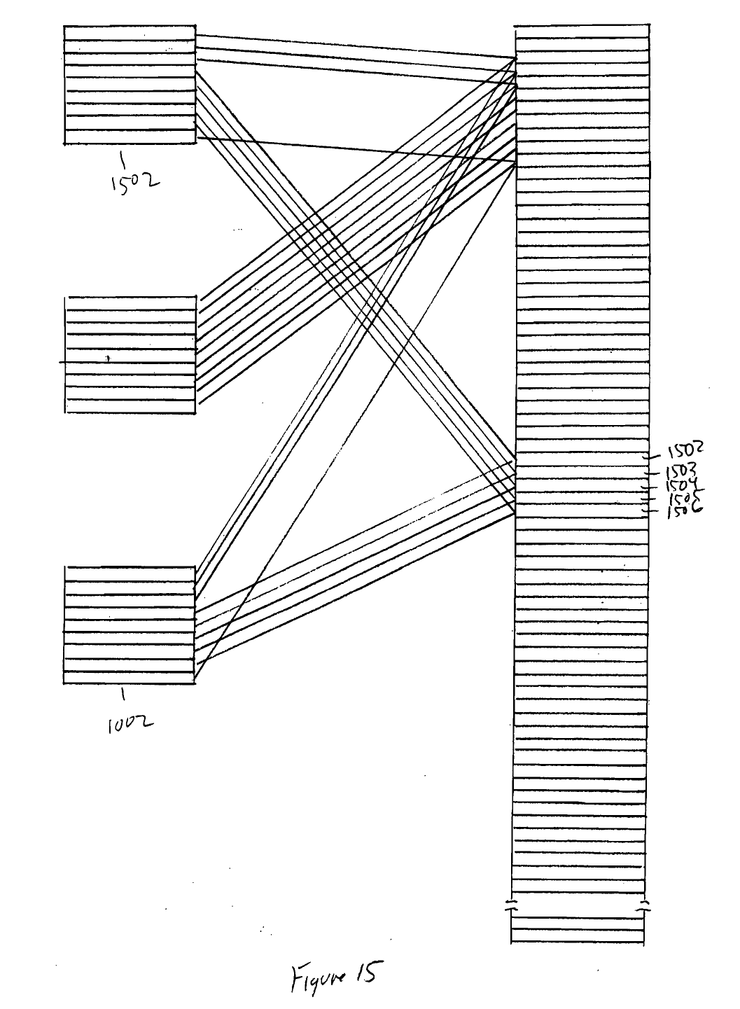

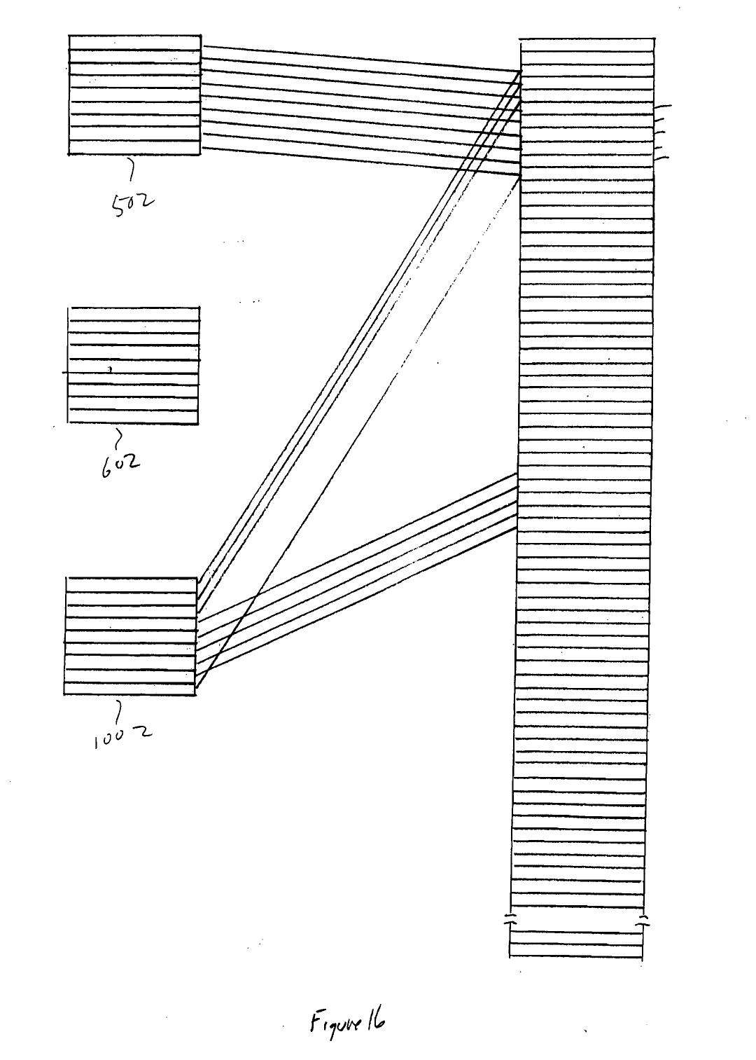

FIG. 15 illustrates a second, successive snapshot operation according to one embodiment of the present invention. Note that, as shown in FIG. 15, the second snapshot operation references newly allocated storage-allocation units 1502-1506 referenced by the original logical unit 1502. In other words, each successive snapshot operation references the storage-allocation units in logical storage-allocation-unit address space currently referenced by the original snapshot logical unit. FIG. 16 shows a restore operation directed to a first snapshot logical unit according to one embodiment of the present invention. As can be seen in FIG. 16, the restore operation directed to the first snapshot logical unit 602 has restored the original logical-unit map 502 to its original state. However, the second snapshot logical unit continues to reference storage-allocation units containing the data state of the original-logical unit at the time that the second snapshot operation was undertaken. Thus, in the snapshot-operation embodiment of the present invention, each snapshot in a series of successive snapshots created from a logical unit is independent from the others with respect to restore operations directed to any or all of the set of successive snapshot logical units. Furthermore, when WRITE operations are directed to entire preferred storage-allocation units, only a single WRITE operation to mass-storage is needed. Thus, at best, allocate-on-write involves only a single WRITE operation to mass-storage devices, and, at worst, both a READ operation and a WRITE operation. Even in the worst case, the allocate-on-write operation is therefore more efficient than the copy-on-write operation of the traditional snapshot operation.

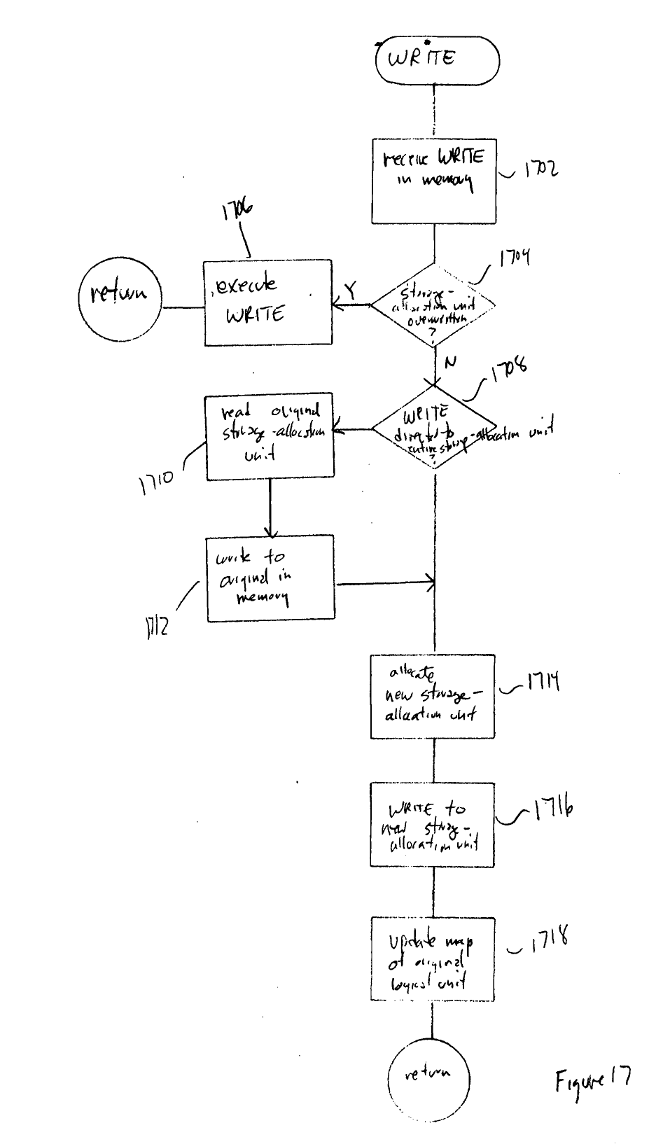

FIG. 17 is a control-flow diagram for writing to a storage-allocation unit not yet overwritten following a snapshot operation according to one embodiment of the present invention. In step 1702, a WRITE operation is received. If the storage-allocation unit to which the WRITE operation is directed has been overwritten since the last snapshot operation directed to the logical unit, as determined in step 1704, then the WRITE can be executed directly, in step 1706, with reference to the internal original-logical-unit map. However, if the storage-allocation unit to which the WRITE operation is directed has not been overwritten since the last snapshot operation, then, in step 1708, the array controller determines whether or not the WRITE operation has the granularity of the preferred storage-allocation unit. If not, then in step 1710, the contents of the current storage-allocation unit are read into memory, and, in step 1712, the WRITE is executed with respect to the in-memory copy of the current contents of the storage-allocation unit. In step 1714, the array controller allocates a new storage-allocation unit from logical-storage-allocation-unit address space. In step 1716, the WRITE operation is carried out to the newly allocated storage-allocation unit. Finally, in step 1718, the map of the original logical unit is updated to reference the newly allocated storage-allocation unit.

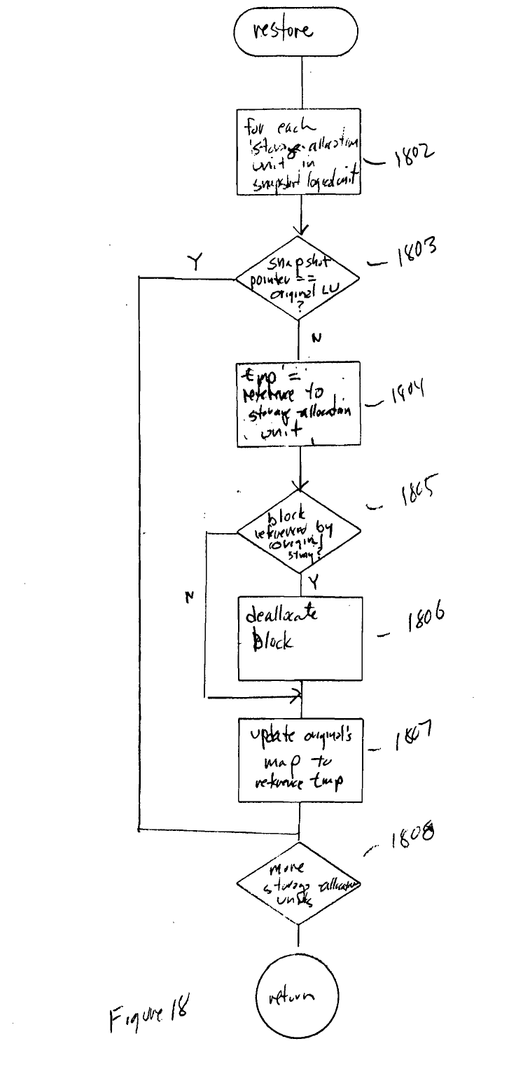

FIG. 18 is a control-flow diagram for a restore operation according to the present invention. In the for-loop of steps 1802-1808, each storage-allocation unit of a most recent snapshot logical unit is considered. If, as determined in step 1803, the currently considered storage-allocation unit is referenced by both the most recent snapshot logical unit and the original logical unit, then nothing needs to be done. Otherwise, in step 1804, a temporary reference is set to reference the currently considered storage-allocation unit. In step 1805, the array controller determines whether the storage-allocation unit currently referenced by the original logical unit is only referenced by the original logical unit. If so, that storage-allocation unit is a stray, and is deallocated in step 1806. Finally, the original logical unit map is updated, in step 1807, to reference the currently considered storage-allocation unit.

Although the present invention has been described in terms of particular embodiments, it is not intended that the invention be limited to these embodiments. Modifications within the spirit of the invention will be apparent to those skilled in the art. For example, the efficient snapshot operation that represents an embodiment of the present invention may be implemented in any number of different programming languages using different control structures, modular organizations, data structures, and by varying other programming parameters. The snapshot operation may be implemented in software, hardware, firmware, or a combination of one or more of software, hardware, and firmware. Embodiments of the present invention include both the enhanced snapshot-operation method, described above, as well as mass-storage arrays and mass-storage-array controllers that employ the enhanced snapshot operation.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for executing a snapshot operation directed to an original data-storage unit and managing a resulting snapshot data-storage unit and the original data-storage unit by a mass-storage-system controller, the method comprising:
creating a logical storage-allocation-unit map for the snapshot data-storage unit by copying, in memory, the a logical storage-allocation-unit map corresponding to the original data-storage unit;
employing allocate-on-write operations to execute WRITE operations directed either to logical storage-allocation units of the original data-storage unit or logical storage-allocation units of the snapshot data-storage unit that are not yet overwritten following the snapshot operation;
continuously defragmenting the logical-storage-allocation-unit address space referenced by the logical storage-allocation-unit map for the original data-storage unit; and
for each successive snapshot operation,
creating a logical storage-allocation-unit map for a next snapshot data-storage unit by copying the current logical storage-allocation-unit map for the original data-storage unit in memory.

2. The method of claim 1 wherein storage-allocation units may include:
sectors;
tracks;
cylinders; and
a combination of one or more sectors, tracks, and cylinders.

3. The method of claim 1 wherein employing allocate-on-write operations to execute WRITE operations directed either to logical storage-allocation units of the original data-storage unit or logical storage-allocation units of the snapshot data-storage unit that are not yet overwritten following the snapshot operation further comprises:
receiving the WRITE operation directed to the logical storage-allocation unit in memory;
determining whether or not the logical storage-allocation unit has been overwritten following the most recent snapshot operation directed to the original data-storage unit; and
when the logical storage-allocation unit has been overwritten following the most recent snapshot operation directed to the original data-storage unit, executing the WRITE operation to the logical storage-allocation unit referenced by the logical storage-allocation-unit map corresponding to the data-storage unit to which the WRITE operation is directed.

4. The method of claim 3 further including, when the logical storage-allocation unit has not been overwritten following the most recent snapshot operation directed to the original data-storage unit:
determining whether or not the WRITE operation is directed to the entire storage-allocation unit; and
when the WRITE operation is not directed to the entire storage-allocation unit, reading into memory the current data state of the storage-allocation unit from the data-storage unit to which the WRITE operation is directed and first executing the WRITE operation to the in memory data state of the storage-allocation unit.

5. The method of claim 4 further including:
allocating a new storage-allocation unit;
executing the WRITE operation, from memory, to the new storage-allocation unit; and
updating the logical storage-allocation-unit map corresponding to the data-storage unit to which the WRITE operation is directed to reference the new storage-allocation unit.

6. A method of claim 1 further including:
receiving a restore operation directed to a snapshot data-storage unit;
for each storage-allocation unit referenced by the storage-allocation-unit corresponding to the snapshot data-storage unit,
determining whether or not the storage-allocation unit is also referenced by the storage-allocation-unit corresponding to the original data-storage unit, and
when the storage-allocation unit is not also referenced by the storage-allocation-unit corresponding to the original data-storage unit,
updating the storage-allocation-unit corresponding to the original data-storage unit to reference the storage-allocation unit.

7. The method of claim 5 further including,
when the storage-allocation unit is not also referenced by the storage-allocation-unit corresponding to the original data-storage unit,
determining whether or not the storage-allocation-unit instead referenced by the storage-allocation-unit corresponding to the original data-storage unit is singly referenced, and
when the storage-allocation-unit corresponding to the original data-storage unit is singly referenced, deallocating the storage-allocation-unit corresponding to the original data-storage unit.

8. The method of claim 1 wherein the logical-storage-allocation-unit maps corresponding to the original data-storage unit and snapshot data-storage units reference a logical storage-allocation-unit address space that maps storage-allocation-unit addresses to cache memory and mass-storage devices.

9. A mass-storage-array controller that executes a snapshot operation directed to an original data-storage unit and manages a resulting snapshot data-storage unit and the original data-storage unit by:
creating a logical storage-allocation-unit map for the snapshot data-storage unit by copying, in memory, the a logical storage-allocation-unit map corresponding to the original data-storage unit;
employing allocate-on-write operations to execute WRITE operations directed either to logical storage-allocation units of the original data-storage unit or logical storage-allocation units of the snapshot data-storage unit that are not yet overwritten following the snapshot operation;
continuously defragmenting the logical-storage-allocation-unit address space referenced by the logical storage-allocation-unit map for the original data-storage unit; and
for each successive snapshot operation,
creating a logical storage-allocation-unit map for a next snapshot data-storage unit by copying the current logical storage-allocation-unit map for the original data-storage unit in memory.

10. The mass-storage-array controller of claim 8 comprising:
one or more processors that execute routines that execute READ, WRITE, snapshot, and restore operations and manage data-storage units;
cache memory;
a port to first communications-medium through which the mass-storage-array controller communicates with remote host computers; and
a second communications medium by which the mass-storage-array controller communicates with mass-storage devices.

11. The mass-storage-array controller of claim 9 wherein storage-allocation units may include:
sectors;
tracks;
cylinders; and
a combination of one or more sectors, tracks, and cylinders.

12. The mass-storage-array controller of claim 9 wherein employing allocate-on-write operations to execute WRITE operations directed either to logical storage-allocation units of the original data-storage unit or logical storage-allocation units of the snapshot data-storage unit that are not yet overwritten following the snapshot operation further comprises:
receiving the WRITE operation directed to the logical storage-allocation unit in memory;
determining whether or not the logical storage-allocation unit has been overwritten following the most recent snapshot operation directed to the original data-storage unit; and
when the logical storage-allocation unit has been overwritten following the most recent snapshot operation directed to the original data-storage unit, executing the WRITE operation to the logical storage-allocation unit referenced by the logical storage-allocation-unit map corresponding to the data-storage unit to which the WRITE operation is directed.

13. The mass-storage-array controller of claim 11 further including, when the logical storage-allocation unit has not been overwritten following the most recent snapshot operation directed to the original data-storage unit:
determining whether or not the WRITE operation is directed to the entire storage-allocation unit; and
when the WRITE operation is not directed to the entire storage-allocation unit, reading into memory the current data state of the storage-allocation unit from the data-storage unit to which the WRITE operation is directed and first executing the WRITE operation to the in memory data state of the storage-allocation unit.

14. The mass-storage-array controller of claim 12 further including:
allocating a new storage-allocation unit;
executing the WRITE operation, from memory, to the new storage-allocation unit; and
updating the logical storage-allocation-unit map corresponding to the data-storage unit to which the WRITE operation is directed to reference the new storage-allocation unit.

15. A mass-storage-array controller of claim 9 further including:
receiving a restore operation directed to a snapshot data-storage unit;
for each storage-allocation unit referenced by the storage-allocation-unit corresponding to the snapshot data-storage unit,
determining whether or not the storage-allocation unit is also referenced by the storage-allocation-unit corresponding to the original data-storage unit, and
when the storage-allocation unit is not also referenced by the storage-allocation-unit corresponding to the original data-storage unit,
updating the storage-allocation-unit corresponding to the original data-storage unit to reference the storage-allocation unit.

16. The mass-storage-array controller of claim 14 further including,
when the storage-allocation unit is not also referenced by the storage-allocation-unit corresponding to the original data-storage unit,
determining whether or not the storage-allocation-unit instead referenced by the storage-allocation-unit corresponding to the original data-storage unit is singly referenced, and
when the storage-allocation-unit corresponding to the original data-storage unit is singly referenced, deallocating the storage-allocation-unit corresponding to the original data-storage unit.

17. The mass-storage-array controller of claim 9 wherein the logical-storage-allocation-unit maps corresponding to the original data-storage unit and snapshot data-storage units reference a logical storage-allocation-unit address space that maps storage-allocation-unit addresses to cache memory and mass-storage devices.
